(19) United States
(12) Patent Application Publication
(10) Pub. No.: US 2022/0410728 A1
(43) Pub. Date: Dec. 29, 2022

(54) UTILITY VEHICLE WITH A HYDROGEN FUEL CELL POWER SUPPLY WHICH PROVIDES MULTIPLE DC AND AC VOLTAGES

(71) Applicant: Jesse N. Marquez, Wilmington, CA (US)

(72) Inventor: Jesse N. Marquez, Wilmington, CA (US)

(21) Appl. No.: 17/877,258

(22) Filed: Jul. 29, 2022

Related U.S. Application Data
(60) Provisional application No. 63/208,157, filed on Jun. 8, 2021.

(51) Int. Cl. B60L 50/70; B60L 1/00; B60W 30/08; B60W 50/14; B60L 53/20; B60L 3/00; B60K 1/04; F41H 7/02; H01M 16/00; H01M 10/42; H01M 8/04664; H02S 10/40; H02S 10/10

(52) U.S. Cl. CPC B60L 50/70; B60L 1/00; B60W 30/08; B60W 50/14; B60L 53/20; B60L 3/0053; B60K 1/04; F41H 7/02; H01M 16/006; H01M 10/425; H01M 8/04664; H02S 10/40; H02S 10/10; B60W 2420/52; B60W 2420/54; B60W 2420/40; B60W 2555/00; B60W 2420/42; B60L 2210/10; B60L 2210/40; B60H 1/00392

(57) ABSTRACT

A hydrogen fuel cell, PV solar panel, and thermoelectric power generator powered all-electric mobile utility vehicle with an onboard regulated power supply with multiple power outlets and charging ports that uses DC/DC converters and DC/AC inverters to provide multiple DC and AC voltages to power or charge multiple external electrical devices, electronic instruments, electronic equipment, communications equipment, power tools, and vehicles simultaneously. A utility vehicle integrated with a component thermal management system GPS, Wi-Fi, ADAS, automotive Ethernet, telecommunications, real-time data reporting, warning notification capable, weather station, environmental sensors, with EMI, RFI, high voltage surge protection, circuit breakers, computer and supporting software programs which can be used in on-road, off-road and emergency response situations.

### CROSS-REFERENCE TO RELATED APPLICATIONS

This application claims priority from a U.S. Provisional Patent Appl. No. 63/208,157 filed on Jun. 8, 2021, which is incorporated herein by reference in its entirety.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file, or records, but otherwise reserves all copyright whatsoever.

### FIELD OF INVENTION

The present invention relates to a hydrogen fuel cell powered mobile utility vehicle, and more particularly, the present invention relates to a hydrogen fuel cell powered mobile power utility vehicle with an additional hydrogen fuel cell power supply that provides multiple DC and AC voltage options, multiple types of power outlets and charging ports.

### BACKGROUND

There is a critical need for a clean and portable power supply station, which provides a variety of DC and AC voltages that do not create air pollution and greenhouse gases. Existing transportable power generator technologies use gasoline or diesel fuel which creates and release criteria pollutants, toxic pollutants, and greenhouse gases. Electric battery power sources are available as alternatives, however, they typically last less than 24 hours. Longer-lasting electric battery sources are large, bulky, and heavy which limits their portability. Moreover, there is a limitation on the number of devices that can be connected to electric battery power sources.

Another major drawback with existing portable power supplies is the availability of either DC or AC voltages which makes their use extremely limited considering the wide range of electric power devices, such as 3.7 V DC drone batteries, 5 V DC cell phones, 12 V DC car batteries, 18 V DC electric drills, 48 V DC tethered underwater UMV, 288 V DC Lexus, 300 V DC GM Yukon, 336 VD Ford Hy Series, 500 V DC Prius, 120 V AC fans and 220 VAC tower lights.

There exists no portable EV charging stations or portable power generators that have the special EV Vehicle charging ports to plug into. A construction project could easily have twenty or more different equipment voltage power needs.

There is also a serious need for portable flexible mobile power supply backup technology in emergency response situations such as natural disasters, wildfires, power grid failures, and industrial facility accidents. There exists no portable mobile power supply that can drive to an urban community, the ocean coast, or a remote mountain location and provide instant power for more than twenty different electric devices simultaneously. There is an equally important need in police enforcement, private industrial security, homeland security, military preparedness, and field operations.

There is also a need to eliminate the U.S. economic dependence on politically unstable countries, world regional foreign alliances for maintaining soaring prices of fossil fuels and more recently hackers interrupting oil, fuel, and gas supplies for ransom. Global warming and climate change are now severely impacting the US and the world, and the solution is to reduce criteria air pollutants, toxic air pollutants, and greenhouse gases.

A need is therefore appreciated for a mobile utility vehicle power supply/station that overcomes the drawbacks and limitations in the known portable power stations, mobile utility power supplies, and the like.

### SUMMARY OF THE INVENTION

The following presents a simplified summary of one or more embodiments of the present invention to provide a basic understanding of such embodiments. This summary is not an extensive overview of all contemplated embodiments and is intended to neither identify critical elements of all embodiments nor delineate the scope of any or all embodiments. Its sole purpose is to present some concepts of one or more embodiments in a simplified form as a prelude to the more detailed description that is presented later.

The principal object of the present invention is therefore directed to a mobile utility vehicle that has multiple AC and DC power supply options with a range of voltages available for powering external and internal electronic devices.

It is another object of the present invention that the mobile utility vehicle is environment friendly that does not emit greenhouse gasses, air pollutants, and generate any hazardous waste materials.

It is still another object of the present invention that the mobile utility vehicle includes internet, Wi-Fi, and precise GPS location information.

It is yet another object of the present invention that the mobile utility vehicle has a telecommunication unit, real-time video streaming, data receipt, and data transfer capabilities that are critical to real-time information needs, situation analysis, emergency response, and command center coordination.

It is a further object of the present invention that the mobile utility vehicle is equipped with an all-digital meteorological weather station and environmental monitoring sensors.

It is still a further object of the present invention that the mobile utility vehicle can be commissioned to go to a natural disaster area such as a tornado, hurricane, tsunami, or wildfire in which rapid changing weather conditions is critical to know for early evacuation.

In one aspect, disclosed is a hydrogen fuel cell-based mobile utility vehicle that provides multiple DC and AC voltages, a comprehensive thermal management system, and has multiple outlets and charging ports to power or charge a range of external electronic devices simultaneously.

In one aspect, disclosed is an all-electric mobile utility vehicle built on an original equipment manufacturer (OEM) hydrogen fuel cell-powered cab chassis, which is powered by hydrogen fuel cells, solar panels, thermoelectric power generator, and redundant power batteries with an onboard regulated power supply with multiple power outlet types and charging ports which provides multiple DC and AC voltages to power or charge different external electronic devices, electronic instruments, electronic equipment, and vehicles simultaneously.

In one aspect, disclosed is a utility vehicle integrated with protective equipment enclosed cabin body, hydrogen gas tanks, proton exchange membrane (PEM) hydrogen fuel cells, thermal management system, Global Positioning System (GPS), GPS connectivity to all major satellite networks, Wi-Fi enabled, Advanced Driver Assistance Systems (ADAS), automotive Ethernet, telecommunications, warning notification capable, all-digital weather station, environmental sensors, real-time sensor monitoring, and data reporting, with electromagnetic interference (EMI), radio frequency interference (RFI), and high voltage surge protection, circuit breakers, maximized solid-state components, fiber optic sensors, component shock, vibration and noise dampening mounts, computer and supporting software programs which can be used in on-road, off-road and emergency response situations.

### BRIEF DESCRIPTION OF THE DRAWINGS

The accompanying figures, which are incorporated herein, form part of the specification and illustrate embodiments of the present invention. Together with the description, the figures further explain the principles of the present invention and enable a person skilled in the relevant arts to make and use the invention.

FIG. 1 is a schematic top open roof illustration of a mobile utility vehicle, according to an exemplary embodiment of the present invention.

FIG. 2 is a schematic view of a top roof illustration of solar panels, GPS/Wi-Fi module, and weather station, according to an exemplary embodiment of the present invention.

FIG. 3 is a side open illustration of the mobile utility vehicle showing interiors with the GPS/ADAS plus on top of the roof, according to an exemplary embodiment of the present invention.

FIG. 4 is another side view showing the interior of the mobile utility vehicle with the rain protection roof awning extended, according to an exemplary embodiment of the present invention.

FIG. 5 is an illustration of a sample power supply panel, according to an exemplary embodiment of the present invention.

### DETAILED DESCRIPTION

Subject matter will now be described more fully hereinafter. Subject matter may, however, be embodied in a variety of different forms and, therefore, covered or claimed subject matter is intended to be construed as not being limited to any exemplary embodiments set forth herein; exemplary embodiments are provided merely to be illustrative. Likewise, reasonably broad scope for claimed or covered subject matter is intended. Among other things, for example, the subject matter may be embodied as apparatus and methods of use thereof. The following detailed description is, therefore, not intended to be taken in a limiting sense.

The word “exemplary” is used herein to mean “serving as an example, instance, or illustration.” Any embodiment described herein as “exemplary” is not necessarily to be construed as preferred or advantageous over other embodiments. Likewise, the term “embodiments of the present invention” does not require that all embodiments of the invention include the discussed feature, advantage, or mode of operation.

The terminology used herein is to describe particular embodiments only and is not intended to be limiting to embodiments of the invention. As used herein, the singular forms “a”, “an”, and “the” are intended to include the plural forms as well, unless the context indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

The following detailed description includes the best currently contemplated mode or modes of carrying out exemplary embodiments of the invention. The description is not to be taken in a limiting sense but is made merely to illustrate the general principles of the invention since the scope of the invention will be best defined by the allowed claims of any resulting patent.

The following detailed description is described with reference to the drawings, wherein like reference numerals are used to refer to like elements throughout. In the following description, for purposes of explanation, specific details may be set forth to provide a thorough understanding of the subject innovation. It may be evident, however, that the claimed subject matter may be practiced without these specific details. In other instances, well-known structures and apparatus are shown in block diagram form to facilitate describing the subject innovation. Moreover, the drawings may not be to scale.

Disclosed is an all-electric mobile utility vehicle built on an OEM hydrogen fuel cell-powered cab chassis and a reference all-aluminum extra strength 8′ W×8′ H×18′ L cabin body for commercial applications or for military applications built with protective reinforced metal plates and/or composite materials with an onboard hydrogen fuel cell powered regulated power supply with a minimum of 160 kW of electric power supply with multiple power outlet types and charging ports which provides multiple DC and AC voltages to power or charge multiple external electrical devices, electronic instruments, electronic equipment, and vehicles simultaneously. With an optimized safety, reliability, durability, redundant, solid-state components, wireless components, environmental sensor, power, heat, and energy management system.

The mobile utility vehicle includes proton exchange membrane (PEM) hydrogen fuel cells installed in the rear cabin body, which includes a comprehensive thermal management system, PEM fuel cells offer superior design flexibility in the design shape and size to meet all voltage range requirements, can accommodate all space constraints, have superior chemical stability, increased lifetime performance and more efficiency than internal combustion engines, operate in all weather conditions, hydrogen gas refuels hydrogen fuel cells 4×-5×faster than recharging batteries, have lower operating costs, reduced maintenance, lower downtime, have extended travel range, are significantly quieter and can be operated indoors or in crowded areas because they are zero emissions.

Disclosed is a compact all-electric mobile vehicle that is scalable and can be manufactured in various heights, widths, lengths, and shapes in which all vehicle components and accessories are modular and have maximum space form-fitting. Mobile utility vehicles such as but not limited to on-road and off-road trucks, all-terrain vehicles, cube vans, box trucks, semi-trailer trucks, utility vans, and the like are the best market type for development, manufacturing, or conversion. Said mobile utility vehicles can travel in all directions and over various paved on-road streets, thoroughfares, highways, freeways, bridges, and off-road unpaved gravel roadways, trails, and all-terrains. The mobile utility vehicle includes but is not limited to specific features such as extra component ruggedness, enhanced durability parts design, 4×4-wheel drive, all-wheel drive, regenerative braking, a durable heavy-duty chassis, high ground clearance, flexible suspension, heavy-duty engine, tandem tow hitch, axial, and component shock-vibration-noise mounts. The mobile vehicle can be manufactured with an open frame and open components or enclosed in a waterproof side or back door roll-up door cabin body housing. The mobile utility vehicle can also be made into police, private tactical security, homeland security, or military version which has GPS, satellite communications, extra exterior protective armor, special blast-resistant glass, rugged off-road tires, military tires, undercarriage plating, ruggedized components, enclosed ingress protected equipment and extreme weather protection features.

The disclosed mobile utility vehicle includes a heavy-duty all-electric powertrain drive with high torque, minimum moving parts, minimal maintenance, and long service life, provides vehicle propulsion over various paved on-road streets, thoroughfares, highways, freeways, bridges, and off-road unpaved gravel roadways, trails, and all-terrains. The heavy-duty all-electric powertrain drive and electronic accessories of the disclosed mobile utility vehicle can be powered by a plurality of one or more interconnected hydrogen fuel cells which provide electrical power to operate the mobile utility vehicle and provide power to allow said mobile utility vehicle to travel.

The disclosed mobile utility vehicle can have a plurality of highly efficient PV solar energy panels which are installed on the cabin body roof with supporting energy storage batteries installed in the cabin body which provides renewable auxiliary redundant power, backup power, and fast start-up hydrogen fuel cell power if needed. PV Solar panels are a renewable energy source, generate their electrical power with no fossil fuel internal combustion engine, are exceptionally reliable, require no gas tanks, have extremely low operation and maintenance costs, create electricity with no moving parts, reduce dependence on nonrenewable fossil fuels, are silent, no noise, and are zero emissions, zero greenhouse bases and generate no hazardous wastes.

The disclosed mobile utility vehicle features an enclosed cabin body built on a cab chassis or is scalable to accommodate smaller or larger mobile vehicles. Certain embodiments of the disclosed mobile utility vehicle are described as having an 18-ft length box truck as a reference, but it can be scaled to size for any mobile utility vehicle, cabin body length, and application purpose. The mobile vehicle includes a cabin body to protect all components and equipment from extreme weather conditions such as rain, snow, moisture, wind, dust, sand, and heat. An enclosed lockable cabin body also provides security to prevent theft, damage, or tampering.

The cabin body can be made of 100% pure high-strength aluminum which is approximately 45% lighter than steel. The cabin body can have a roof, floor, two side walls, a front side wall, and a rear wall with rear door access. The cabin body can be made of fully welded bonded construction, with no bolts or rivets to loosen and fall out from side skins or frames. The cabin body features a high-security lockable standard door or wide side or rear roll-up doors, a heavy-duty frame, an extendable metal pull-out canopy awning for extra protection when raining, extreme sunlight, and heat, and one or more side roll-up doors. Aluminum's rust resistance increases the durability and longevity of the cabin body.

The cabin body can also be fabricated with other types of cabin construction materials such as lightweight fiberglass, carbon fiber filament, carbon fiber enforcement, and carbon nanotubes.

The cabin body assembly includes a one-piece crowned roof, low-power 100% LED lights, LED clearance and marker lights, LED interior round dome, box or string lights, roof racks, and closeable wall vents. An automatic light sensor can also be provided that turns on the light when it becomes dark.

A lighter aluminum cabin lowers the vehicle's center of gravity, increases the maneuverability of the vehicle, allows a tighter turning radius, has improved acceleration and braking, and lowers fuel costs and better fuel mileage. The use of lightweight aluminum can result in about 10% savings in fuel than the use of heavier steel. It also reduces overall mobile vehicle wear and tears on tires, engine shock mounts, shock absorbers, and struts. The cabin body has independent air conditioning and a heating system. In certain implementations, the cabin body can also be provided with a powder coat finish which is a more durable and long-lasting finish compared to traditional vehicle metal paint. This durability and longevity reduce maintenance, replacement costs, and frequency of replacement.

The high-pressure compressed hydrogen gas tanks to store hydrogen gas can be encased within the cabin body. The stored hydrogen gas in the tanks can be used by the hydrogen fuel cells to produce the DC/AC electrical power. High-pressure tanks with standard pressures of 500 bar, 700 bar, and other approved standards can be used depending on the requirements, such as the amount of DC power required and the time duty cycle. The storage tanks can be fabricated in many sizes, shapes, and materials, preferably that can be fitted in the cabin body and occupies the least space. The tanks can be interconnected with metal conduit piping, valves, pumps, pressure regulators, valves, and sensors. In one implementation, Type III Aluminum Tanks, Type IV HDPE Tanks, and other approved storage tanks that meet the industry-standard ISO/TS 15869:2009 Gaseous Hydrogen and Hydrogen Blends-Land Vehicle Fuel Tanks can be used.

Hydrogen gas sensors that can detect hydrogen gas leaks and hydrogen concentration from 0-100% can also be used. The sensors can be connected to devices for audio and visual alarms in case of any deviation from normal, and provides data for sensor failure and disconnect detection, including resettable flash arrestors for protection against flashbacks, a built-in non-return (check) valve to stop the reverse flow and a thermal shut-off which stops gas flow in the event an of hose or pipeline fire.

The hydrogen gas tanks can be permanently installed or be exchangeable by being swapped out, stored, and locked in place in a vertical or horizontal position inside a rectangular metal rack fixture which has a plurality of rubber or equivalent material mounts for shock, vibration, and noise dampening placed at different strategic safety distances locations. Shock mounts are important to minimize shock loads expected during loading and unloading, sudden stops, street potholes, uneven roadways, and rocky terrain. There are multiple rows of stack fixtures, which are stacked to accommodate a plurality of tanks in height. The tanks can be placed forward in the enclosed cabin but can be evenly distributed as necessary to balance weight. The vehicle can have an onboard hydrogen gas fuel filler nozzle connection to refill the hydrogen gas in the permanently installed tanks or exchangeable tanks.

The vehicle design includes one or more hydrogen pressure regulators, controllers, supporting components, pumps, valves, piping, pressure gauges, and sensors to monitor the hydrogen gas storage, rate, flow, and consumption. Hydrogen gas sensors can detect hydrogen gas leaks and hydrogen concentration from 0-100%, have audio and visual alarms, and provides data for sensor failure and disconnect detection. The vehicle includes resettable flash arrestors for protection against flashbacks, a built-in non-return (check) valve to stop the reverse flow and a thermal shut-off that stops gas flow in the event a of hose or pipeline fire.

The vehicle design includes shock, vibration, and noise dampening mounts comprising extra-strength rubber, synthetic rubber, polyurethane, Sorbothane, silicone, or equivalent cushioning materials for fastening and holding in-place special identified sensitive or critical components such as gas tanks, fuel cells, other fragile components, and equipment onto the floor, walls, roof or in stacked equipment. Not shown in diagrams.

The vehicle design includes temperature controllers, monitors, wiring, and one or more component GaAs technology fiber optic temperature sensors. The temperature sensors are for monitoring the internal heat of fuel cells, tanks, and heat dissipation through radiators, battery packs, cables, terminals, electric drivetrain, identifying electric drivetrain premature insulation failure, hydrogen and water storage tanks, transmission, and power electronics. The invention will also use robust fiber optic and MEMS technology pressure sensors. Fiber optic components are immune to electromagnetic, and radio frequencies and withstand elevated temperatures, harsh environments, and have high shock survivability.

The vehicle design includes the use of highly accurate GaAs technology fiber optic temperature sensors and monitors which have built-in redundancy, are small up to 0.4 mm in diameter, and fast and accurate. They can detect small temperature variances such as loose hardware wire joint connections. These types of sensors are intrinsically safe, provide real-time data, operate under high voltage conditions, are solvent and chemical resistant, and perform in harsh and corrosive environments. The Fiber-optic temperature sensors can also offer higher immunity to electromagnetic EMI, ESD, and RFI which increases the testing accuracy and repeatability, a faster response time of 0.1 seconds to 1 ms significantly improves in identifying sudden temperature spikes within hydrogen fuel cells. Moreover, a rugged sensor tip (vibration withstand capability of 8 g) may be suitable for all-terrain test conditions. The sensors and monitors are easy to reuse as they do not require recalibration or complex inputs to operate. Not shown in diagrams. The vehicle design GaAs fiber optic temperature sensors can be provided as plug and play interface and may not require expensive calibration. These special types of rugged sensors can also be used in medical, aerospace, and military applications. However, any type of temperature sensor can be used without departing from the scope of the present invention.

In a preferred embodiment, the cabin body can include an installed regulated electric power supply and power supply panel built with an array of multiple commercial and specialized electrical power outlets and EV charging ports, which can provide power to multiple types of external devices which require electrical power to operate or to recharge.

The power panel may include one or more on-off switches, voltage regulators, voltage power gages, multiple type DC and AC power outlets, and electrical charging ports. The hydrogen fuel cell power supply will provide a wide range of DC voltages ranging from 1 V to 1000 V and standard US AC voltages ranging from 100 V to 250 V.

The vehicle's DC voltage range can power or recharge cell phones, cameras, motion detectors, walkie-talkies, police/security/emergency response radios, radio frequency scanners, military two-way tactical band radios, satellite cellular phones, satellite MUOS radios, communication towers, tablets, laptop computers, desktop computers, external hard drives, drones, tethered hoover-in-place drones, tethered underwater UMVs, satellite communication antennae's, internet base stations, car battery, motorcycle battery, electric vehicle battery, power tools, PA systems, portable lighting, portable tower lighting, air quality, and weather monitoring instruments. The disclosed mobile utility vehicle AC voltage range can allow every electrical device, electronic instrument, electronic equipment, and vehicle to operate or be charged using standard power outlets.

The disclosed mobile utility vehicle can also include an on-board flexible power supply backup technology that can be used in emergency response situations such as natural disasters, power grid failures, and industrial facility accidents. There is an equally important need in police enforcement, private industrial security, homeland security, military preparedness, and field operations.

The mobile utility vehicle can include technology options supporting the current 4G, 5G, LTE, Wi-Fi networks, 6G, 7G, and future enabled networks, automotive Ethernet, and the new next generations' state-of-the-art automotive connectivity technology dual-band MU-MIMO Wi-Fi 6 and next Wi-Fi 7. The present Wi-Fi 6 allows high-speed 10 GbE port connections, allows the setting up of multiple networks, and allows up to 3600 Mbps dual band 2 GHz and 5 GHz transfer speeds. The Wi-Fi 6 provides enterprise-grade SD-WAN VPN to allow multi-site VPN deployment via the cloud. SD-WAN technology automatically establishes a secure mesh VPN with ANAP devices at multiple sites and supports up to six SSID groups for different VLAN settings. The vehicle Wi-Fi 6 and Wi-Fi 7 support real-time streaming of high-speed data, HD voice and video streaming uplink, downlinks, multiple displays, screen mirroring, wireless backup camera, and Bluetooth 5.1. Wi-Fi 6 routers have max router throughput of 400 Mbps making them rated for up to 150 users.

The mobile utility vehicle can include antenna options for 5-in-1, 7-in-1, and 9-in-1 outdoor antenna ports that support 600 MHz to 6 GHz, support for LTE Band 14 First Responder Network, Band 71 for T-Mobile, CBRS, and LAA. The 9-in-1 antenna includes the first of its kind new state-of-the-art Dual 6×6 MIMO Wi-Fi, Dual LTE, and multi-GNSS technology antennas in one compact unit. Telecommunications, data receipt, and data transfer are critical to real-time information needs, situation analysis, emergency response, and command center coordination. This invention allows the inclusion of GPS connectivity to all major satellite networks: GNSS, L-Band Communications Satellites, Galileo, QZSS, and BeiDou. The vehicle antenna is a high-performance, heavy-duty, compact, low-profile external MIMO antenna that supports gigabit-class GPS, Wi-Fi, and automotive Ethernet. MIMO antennas are highly efficient, high gain, low noise, with high isolation for more accurate geolocation and navigation with better signal reception, all of which is necessary to achieve the required signal-to-noise ratio and throughput. The antenna does not require a metallic ground plane.

The disclosed mobile utility vehicle can also include Advanced Driver Assistance Systems (ADAS)+Plus which provides standard industry state-of-the-art driver and vehicle status information and protection features such as early warning systems for driver incognizance, collision prevention, roadway obstructions, object proximity and distance using GPS, Wi-Fi, automotive Ethernet, Lidar, Radar, Sonar, ultrasonic sensors, infrared sensors and additionally includes +Plus features such as all-digital intelligent navigation systems, inertial measurement units (IMU), environmental monitoring sensors, and weather station to provide additional real-time information and safety status regarding a broad range of weather conditions, altitude, visibility, light detection, rising water, noise and earthquake ground motion information.

The utility vehicle includes an integrated early warning system composed of one or more subsystems which include sensors and components for monitoring driver incognizance, signal, power, pressure, heat, weather, altitude, visibility, light detection, rising water, noise, and earthquake ground motion, real-time part failure, component malfunctions which automatically disconnect, shut down or initiate corrective actions and activate audio alarms, light turn-on, display monitor alarms, Wi-Fi, automotive Ethernet, Microwave, RF and telecommunication notifications.

Certain types of electronic components and equipment are sensitive to high voltages, power surges, electromagnetic interference (EMI/EMP) and radio frequency interference (RFI) generated from other components and equipment which can cause interruptions, corrupted operation, and failure. This can also be further impacted and complicated by exposure to exterior high voltage, EMI/EMP, and RF sources. The maximum application of shielding can prevent and significantly reduce any negative impacts. This invention maximizes the shielding of cables, connectors, sensitive components, and equipment from high voltage, electromagnetic interference (EMI/EMP), and radio frequency interference (RFI) using metal and metal alloys which include wire braid, foils, screens, meshes, sheets, tape, sealed enclosures, nanowires, and infused metal composite materials, gaskets, inks, paints, coatings, and nanofibers.

The utility vehicle includes a computer with high memory storage, Wi-Fi, and special software programs to manage, monitor, program, operate, initiate corrective actions, display data, sound, images, and videos of connected equipment, and send information, data, signals, sound, images, videos, alerts, and telecommunications.

The utility vehicle includes a low-voltage all-digital meteorological weather station with Wi-Fi connectivity. The vehicle may be commissioned to go to a natural disaster area such as a wildfire, tornado, or hurricane in which rapidly changing weather conditions is critical to know for early evacuation. The weather station meteorological information includes temperature, humidity, barometric pressure, wind direction, wind speed, dew point, and precipitation sensors and measurement instruments as a minimum.

The disclosed utility vehicle can further include power surge protectors, circuit breakers, electromagnetic interference, and pulse protection (EMI/EMP). Surge protectors are well known in the art and generally is a device designed to protect electrical devices from high voltage spikes. A surge protector attempts to limit the voltage supplied to an electric device by either blocking or shorting to ground any unwanted voltages above a safe threshold. A circuit breaker is also known in the art and is a type of electrical switch designed to prevent damage from an overcurrent or short circuit when the current levels exceed safe limits.

The utility vehicle includes seismic and ground-motion detection technologies that provide real-time monitoring for earthquake fault movement and ground movement caused by construction activities, emerging sink holes, cliff-side landslides, and liquefaction.

Liquefaction takes place when loosely packed, water-logged sediments at or near the ground surface lose their strength in response to strong ground shaking caused by earthquakes, sea-level rise, oil well drilling, and above or underground explosions.

The utility vehicle incorporates a thermal management system which can include one or more cooling technologies such as HVAC, heat dissipation technologies for internal and external components but can also be used to heat fuel cells, fuel stacks, storage tanks, pumps, piping, vaporizers, other thermal sensitive components and cabin environments using low to no maintenance air printed circuit heat exchangers, heat pipes, air-cooled heat-sinks, condensers, liquid, and nano-liquid coolant radiators, solid-state thermoelectric modules also called solid-state heat pumps, thermoelectric coolers, and thermoelectric generators which can be single-stage, multi-stage and high power density modules.

The utility vehicle incorporates thermoelectric modules which offer many advantages such as being very low cost, economical, can be fabricated rectangular or in round annular-style shapes, an all-solid-state semiconductor-based electronic component with no moving parts, small, compact, low profile, lightweight, extremely rugged, maintenance-free, acoustically silent and electrically quiet, heating and cooling with the same module (including temperature cycling), wide operating temperature range, highly precise temperature control (to within 0.1° C.), can be attached to flat and circular surfaces, operation in any orientation, vibration less, zero gravity and high G-levels, sub-ambient cooling, cooling to very low temperatures (−80° C.), easily scalable, high-reliability of over 100,000 hours+MTBF, are environmentally friendly requiring no toxic component elements, no CFC's and does not release any toxic gas or greenhouse gas emissions.

The utility vehicle incorporates solid-state thermoelectric modules also called thermoelectric power generation modules which can be single-stage or multi-stage and can generate low power or high-power density modules. The thermoelectric power generator can be attached to any waste heat generating source and converts the thermal heat energy into DC power. Global warming and climate change are now severely impacting the US and the world, and the solution is to reduce criteria air pollutants, toxic air pollutants, and greenhouse gases. This invention an all-electric mobile utility vehicle and electric power supply emits zero emissions, zero greenhouse gases, and generates zero hazardous waste materials.

The utility vehicle can also be configured to include water tanks, water pressure pumps, water purification filters, and an Electrolyzer to create hydrogen. The water purification systems that can produce minimum 99.999% pure water and use any source of potable water, reclaimed, recycled water, lake, river, and sea water. This would allow the utility power supply vehicle to provide power for longer periods of time and in remote locations.

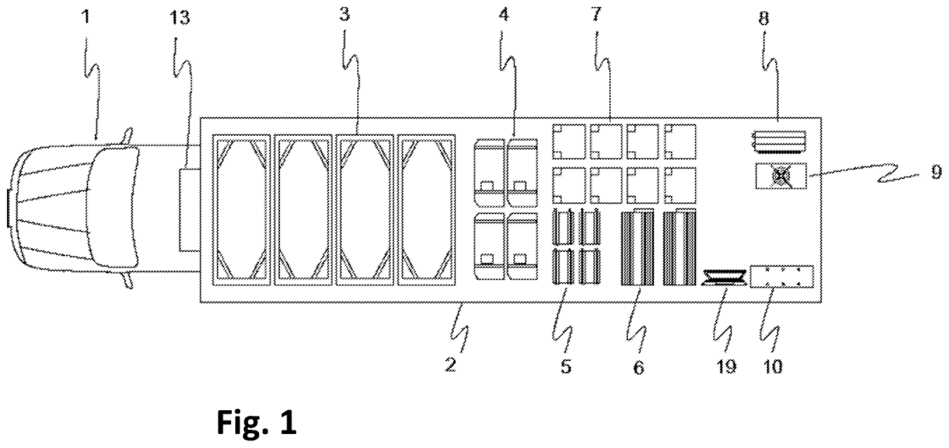

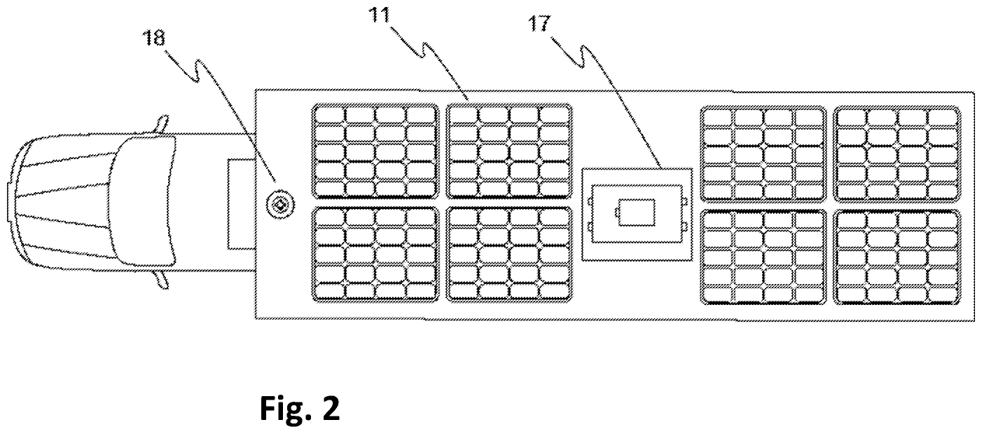

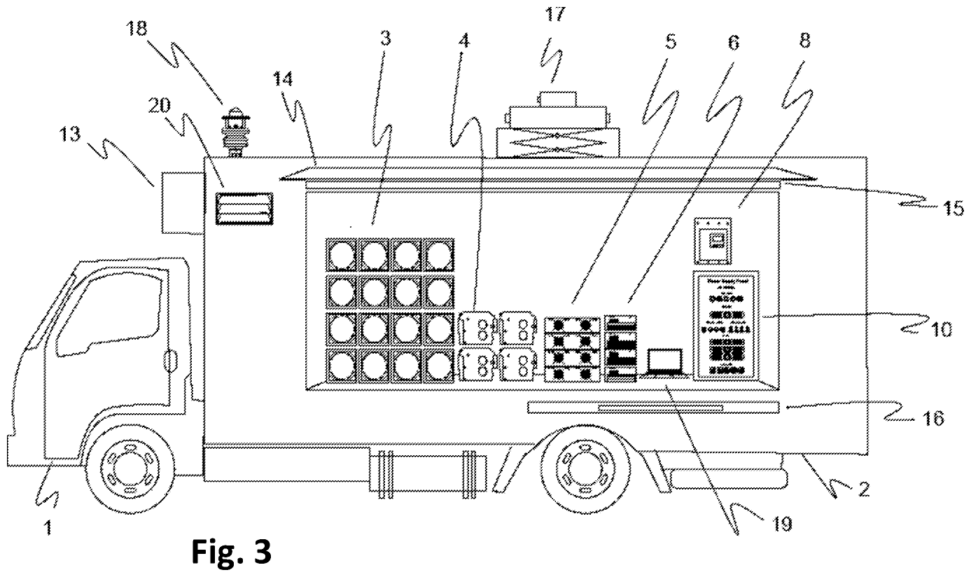

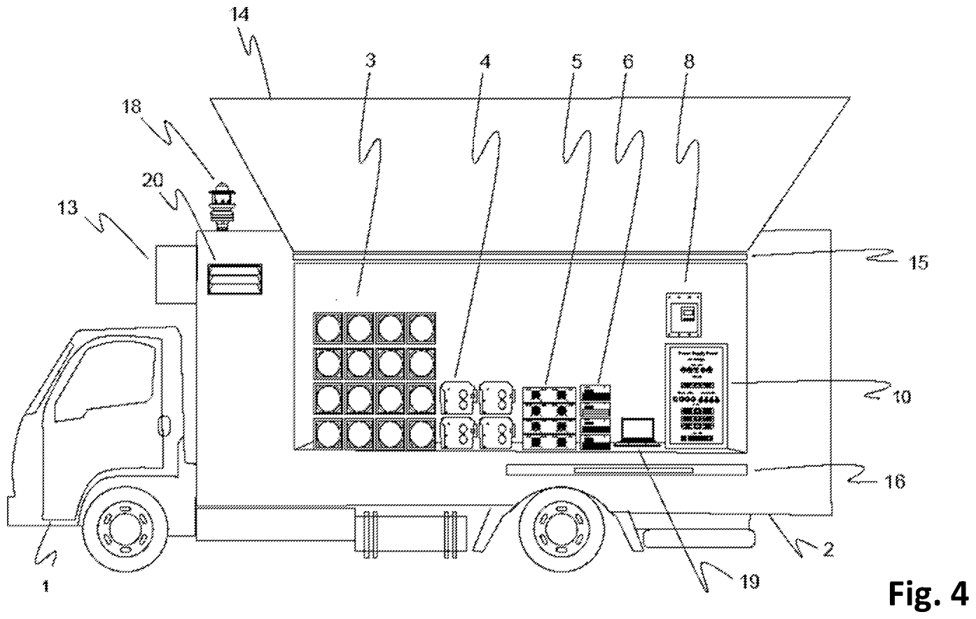

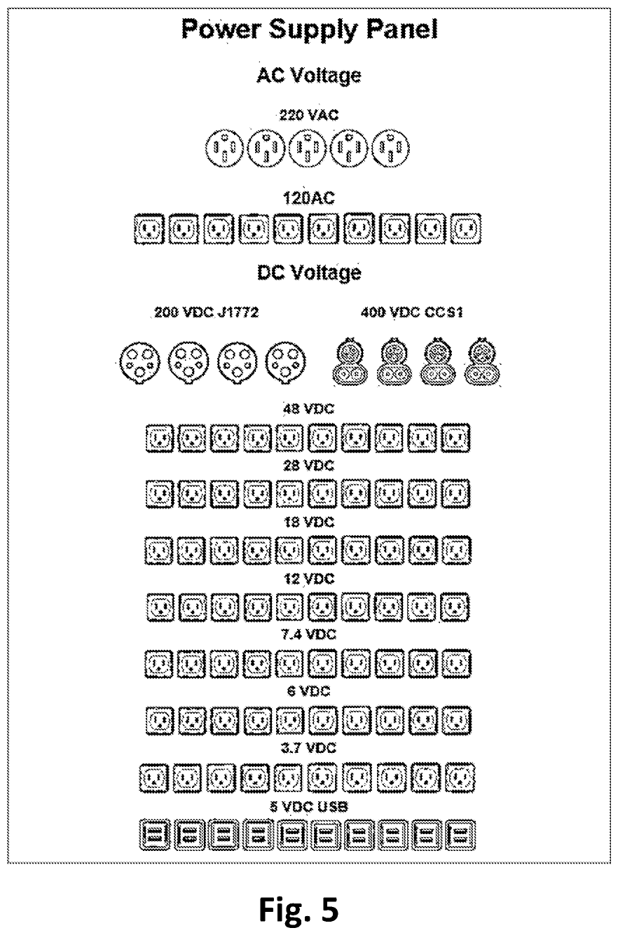

Referring to FIG. 1 is a top open roof view of the disclosed mobile utility power supply vehicle showing the major cabin body interior components including a vehicle front drivers cab 1, rear cabin body 2, hydrogen gas tanks 3, hydrogen fuel cells 4, DC/DC converters 5, DC/AC inverters 6, auxiliary batteries 7, solar converter 8, solar charge controller 9, power panel 10, AC/Heater 13 and computer 19. FIG. 2 is a top roof view of the mobile utility power supply vehicle cabin body showing the PV solar panels 11, GPS/ADAS Plus module 17, and weather station 18. FIG. 3 is a side open view of the mobile utility power supply vehicle showing the major cabin body interior and exterior components; vehicle front drivers cab 1, rear cabin body 2, hydrogen gas tanks 3, hydrogen fuel cells 4, DC/DC converters 5, DC/AC inverters 6, solar controller 8, power panel 10, rain protection roof awning 14, side roll-up door closed 15, side pull-out work table 16, GPS/ADAS Plus module 17, weather station 18, computer 19 and air vent 20. FIG. 4 is a side open view of the mobile utility power supply vehicle showing the major cabin body interior and exterior components; vehicle front drivers cab 1, rear cabin body 2, hydrogen gas tanks 3, hydrogen fuel cells 4, DC/DC converters 5, DC/AC inverters 6, solar controller 8, power panel 10, rain protection roof awning 14, side roll-up door 15 extended, side pull-out work table 16, GPS/ADAS Plus module 17, weather station 18, computer 19 and air vent 20. FIG. 5 is a drawing of the power supply panel showing a variety of DC and AC power outlets, different outlet design types, and vehicle charge ports.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above-described embodiment, method, and examples, but by all embodiments and methods within the scope and spirit of the invention as claimed.

What is claimed is:

1. A mobile utility vehicle comprising:
a vehicle body;
one or more on-board hydrogen fuel cells configured to produce electricity, the one or more onboard hydrogen fuel cells mounted within the vehicle body;
one or more solar panels mounted on the vehicle body, the one or more solar panels configured to produce electricity;
a thermoelectric generator mounted within the vehicle body and configured to generate electricity;
one or more auxiliary redundant power batteries mounted within the vehicle body;
multi-voltage DC/AC power supply mounted within the vehicle body, the multi-voltage DC/AC power supply comprises a plurality of power outlets and a plurality of charging ports, wherein the plurality of power outlets and the plurality of charging ports are configured to power or charge a range of external electrical devices, instruments, equipment, tools, and other electric vehicles simultaneously; and
an advanced driver assistance system, a comprehensive safety management system, and a thermal management system.

2. The mobile utility vehicle according to claim 1, wherein the mobile utility vehicle further comprises GPS circuitry, Wi-Fi circuitry, automotive Ethernet circuitry, and cellular network circuitry.

3. The mobile utility vehicle according to claim 2, wherein the mobile utility vehicle further comprises one or more antennas, 5-in-1, 7-in-1, and 9-in-1 exterior antenna ports, and a low-profile exterior MIMO antenna.

4. The mobile utility vehicle according to claim 3, wherein the mobile utility vehicle further comprises early warning systems for driver incognizance, all-digital intelligent navigation systems, inertial measurement units (IMU), object recognition device, and collision prevention device equipped with solid-state Lidar, Radar, Sonar, ultrasonic sensors, and infrared sensors.

5. The mobile utility vehicle according to claim 4, wherein the mobile utility vehicle further comprises an all-digital weather and environmental monitoring sensors; monitoring cameras; environmental management system configured to detect light, rising water, noise, and ground motion; the mobile utility vehicle further comprises a public emergency notification system configured to transmit data and sends out warning alerts.

6. The mobile utility vehicle according to claim 5, wherein the mobile utility vehicle further comprises seismic and ground motion detection technologies configured to provide real-time monitoring for earthquake, fault movement, and ground movement caused by roadway collapse, emerging sink holes, cliff-side landslides and liquefaction.

7. The mobile utility vehicle according to claim 6, wherein the mobile utility vehicle further comprises a 4×4-wheel or all-wheel drive, automatic transmission and a durable heavy-duty chassis.

8. The mobile utility vehicle according to claim 7, wherein the mobile utility vehicle further comprises blast-resistant glass, protective armor for the vehicle body, cabin, protective chassis undercarriage plating, and an enclosed ingress protected equipment for military applications.

9. The mobile utility vehicle according to claim 8, wherein the mobile utility vehicle further comprises a temperature monitoring system, wherein the temperature monitoring system comprises solid-state and GaAs technology fiber optic temperature sensors.

10. The mobile utility vehicle according to claim 9, wherein the vehicle body is made from aluminum, wherein the vehicle body does not include bolts, rivets, and protective reinforced metal plates, wherein the vehicle body further comprises a side pull-out worktable and a side pull-out rain protection roof awning.

11. The mobile utility vehicle according to claim 10, wherein the vehicle body further comprises shock, vibration, and noise dampening mounts.

12. The mobile utility vehicle according to claim 11, wherein the utility vehicle further comprises an onboard computer, supporting equipment and component software with memory storage.

13. The mobile utility vehicle according to claim 12, wherein the multi-voltage DC/AC power supply comprises multiple types and multiple DC power voltage outlets and vehicle charge ports ranging from 1 VDC to 1,000 VDC and multiple types and multiple AC power voltage outlets ranging from 100 VAC to 250 VAC.

14. The mobile utility vehicle according to claim 13, wherein the multi-voltage DC/AC power supply comprises one or more DC/DC converters and DC/AC inverters.

15. The mobile utility vehicle according to claim 14, wherein the mobile utility vehicle further comprises PV solar panels, solar converter, solar charge controller, wiring, sensors, and auxiliary power storage batteries.

16. The mobile utility vehicle according to claim 15, wherein the mobile utility vehicle further comprises hydrogen storage tanks which can be permanently installed or be exchangeable and replaceable by being swapped-out, fuel cell safety monitoring system that comprises a plurality of sensors configured for detecting extreme heat and cold weather conditions, pressure leaks, equipment breakage, ground displacement, and sensor failure and disconnect detection.

17. The mobile utility vehicle according to claim 16, wherein cables, components and equipment in the mobile utility vehicle are protected by surge protectors and circuit breakers, and shielded from high voltage, electromagnetic interference, and radio frequency interference.

18. The mobile utility vehicle according to claim 17, wherein the mobile utility vehicle further comprises a thermal management system, one or more HVAC systems, air-printed circuit heat exchangers, heat pipes, air-cooled heat-sinks, condensers, liquid and nano liquid coolant radiators, solid-state thermoelectric modules, thermoelectric coolers, and thermoelectric generators.

19. The mobile utility vehicle according to claim 18, wherein the mobile utility vehicle further comprises water tanks, water pressure pumps, water purification filters, and an Electrolyzer to generate hydrogen.
